(19) United States
(12) Patent Application Publication
(10) Pub. No.: US 2007/0180147 A1
(43) Pub. Date: Aug. 2, 2007

(54) System for insertion of advertising content in user-requested internet web pages

(75) Inventor: Colin Alexander Leigh, Bellevue, WA (US)

Correspondence Address: LATHROP & GAGE LC, 2345 GRAND AVENUE, SUITE 2800, KANSAS CITY, MO, 64108, US

(73) Assignee: Connect IT, LLC

(21) Appl. No.: 11/345,177

(22) Filed: Feb. 1, 2006

(51) Int. Cl. G06F 15/16

(52) U.S. Cl. 709/246

(57) ABSTRACT

A method for insertion of advertising content in an Internet web page, located on a target web site and requested by a web client. In one embodiment, a request from the web client for the web page is intercepted and used to retrieve the web page from the target web site. HTML code on the web page is then re-written to generate a modified web page including an ad insertion code fragment. The modified web page is sent to the web client, which executes the code fragment to cause the advertising content to be displayed.

### BACKGROUND

In advertising, it is highly desirable to target advertisements to the appropriate potential customer base, rather than to broadcast the same advertisements to everyone. It has long been known that, for example, advertisements for computers should generally not appear in magazines on cooking and, conversely, advertisements for kitchenware should not appear in magazines on computers. Similarly, advertisers have generally targeted their advertisements on television to programs appropriate for the desired customer base.

It is also well known that an advertisement that is repeated too often will eventually be ignored by consumers. Therefore, an advertiser typically wishes to eliminate duplication and reach as many individuals in the advertiser's target group as possible. The development of networks such as MSN and AOL, and the Internet in general, has led to ‘on-line’ advertising. For example, on the Internet, on-line advertisements will often appear on a web page, in the form of a banner on the top or the bottom of the page. When a user views a web page using a browser, the banner appears at the appropriate location and the user may then try to obtain additional information regarding the advertisement by selecting the advertisement (‘clicking through’ on the banner) through the use of the mouse or other pointing device. This causes an HTTP message to be generated by the browser using the information encapsulated in association with the banner to send a request for an object with a given URL address to a different appropriate web site to access, for example, an advertiser's home page.

Most on-line advertising typically has a poor rate of response because the advertising is untargeted. For example, when browsing through a particular web site, someone who is interested in computers may continually see advertisements for kitchenware, while on the other hand, someone who is not interested in computers may continually see advertisements for computers. Thus it is highly desirable to have a method of targeting the advertising to the appropriate user population.

### SUMMARY

A method is disclosed for insertion of advertising content in an Internet web page, located on a target web site and requested by a web client. In one embodiment, a request from the web client for the web page is intercepted and used to retrieve the web page from the target web site. HTML code on the web page is then re-written to generate a modified web page including an ad insertion code fragment. The modified web page is sent to the web client, which executes the code fragment to cause the advertising content to be displayed.

In another embodiment, when the ad insertion code fragment is executed by the web client, an advertising content request is generated, and the advertising content is then sent to the web client in response to the request.

### BRIEF DESCRIPTION OF THE DRAWINGS

FIG. 1A is a diagram of an exemplary embodiment of the present system for insertion of advertising content in user-requested internet web pages;

FIG. 1B is a diagram of an alternative embodiment in which the Ad Content Server is functionally combined with the proxy server;

FIG. 2A is a diagram sequentially illustrating exemplary contents of a user-requested web page during the process of ad insertion;

FIG. 2B is a diagram illustrating exemplary contents of a user-requested web page;

FIG. 3A is a diagram illustrating exemplary data flow in the present system;

FIG. 3B is a diagram illustrating alternative data flow in the present system; and

FIG. 4 is a flowchart showing an exemplary set of steps performed in operation of one embodiment of the present system.

### DETAILED DESCRIPTION

The present system connects a user with a target website via wireless customer premises equipment that has been placed in a location called a ‘hotspot’ (an area in which wireless access to the Internet is provided). When the user makes an HTTP-based request for an Internet web page, the request is first re-routed to a central server. When the request arrives at the central server, the requested web page is retrieved from the target server via the Internet. Various techniques may then be used to determine which advertising to insert in the content from the target web site. If possible, the HTML content from the target server is re-written to include the selected advertising. The HTML web page including the inserted advertising is then returned to the user.

Hotspots can be found near restaurants, airports, cafes, libraries and other public places. Presently, most hotspot equipment is IEEE 802.11b or IEEE 802.11g compliant and offers some level of security. The final network link with a particular user within a hotspot is wireless, providing a network connection to all users in the surrounding hotspot. Hotspot areas may range from a single room to an entire campus.

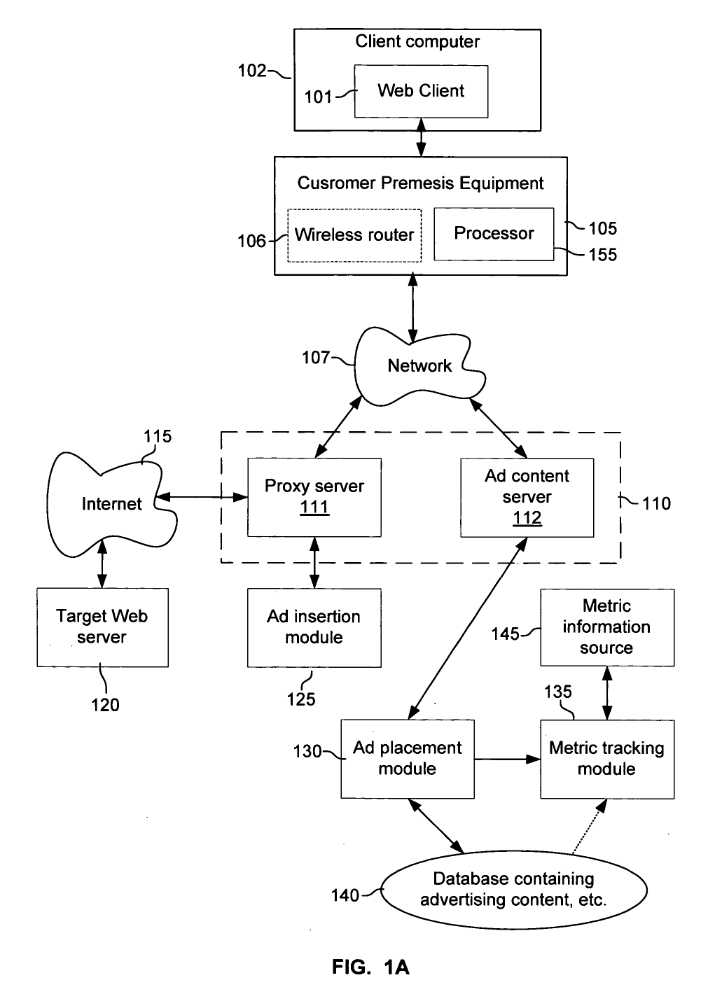

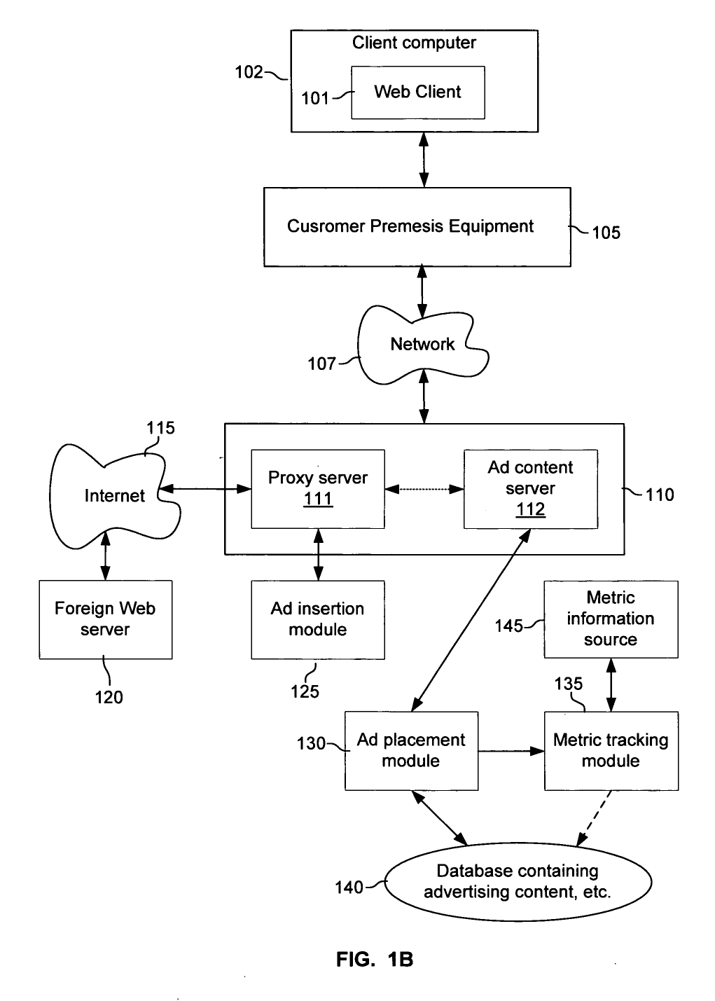

FIG. 1A is a diagram of an exemplary embodiment of the present system for insertion of advertising content in user-requested Internet web pages. As shown in FIG. 1, a web client 101, running on client computer 102 which is located in a hotspot, connects with a target web server 120 via customer premises equipment 105 and a remote proxy server 111 connected to the Internet 115.

As used herein, the term “web client” refers to a software and/or hardware agent, such as an Internet web browser, that implements the HTTP protocol. Web client 101 is typically operated by a third party (e.g., a customer or end-user, hereinafter simply referred to as the “user”). There are many implementations of web agents which are currently commercially or publicly available. Examples of web browsers which are available from commercial providers are Microsoft Internet Explorer and Apple Safari.

For the purposes of this document, a “target web server” 120 is a software and/or hardware agent that implements the HTTP protocol, and which is located within the public Internet. These web servers 120 are not governed or otherwise controlled by the present system. Examples of target web servers include the Apache Foundation's Apache HTTP Server and the Microsoft IIS Server.

In the present system, customer premises equipment 105 includes devices that facilitate a wireless connection to a network 107. Network 107 may be a Virtual Private Network (VPN), the Internet, or other type of communications path between customer premises equipment 105 and proxy server 111. In one embodiment, customer premises equipment 105 includes a device 106, such as a Soekris Engineering net4511 compact communication computer, that has been adapted for use as wireless router using a PC-card, or a Mini-PCI card wireless adapter may be employed, for example.

Proxy server 111 is an HTTP proxy server, which is a software agent responsible for accepting TCP/IP connections from a web client 101, receiving a HTTP request on behalf of the client, and then re-transmitting that request to a target web server 120. When the target web server returns a response to the proxy server 111, that response is then in turn delivered to the requesting web client/browser 101. Proxy server 111 is configured as a transparent proxy server using established network routing techniques.

In the present system, TCP/IP connections are sent to proxy server 111 by the customer premises equipment 105 (e.g., wireless router 106) rather by a configuration on the user's web browser. Proxy server 111 passes HTML content that has been returned by the target web server to an Ad Insertion Module 125 (described below) before returning the HTML content to the user. HTTP proxy servers are well known in the art, and have been used for such purposes as content filtering and caching; thus details concerning their construction are not included herein. In an exemplary embodiment, Proxy server 111 operates in a manner conceptually similar to the open source Squid project (SQUID, http://www.squid-cache.org/).

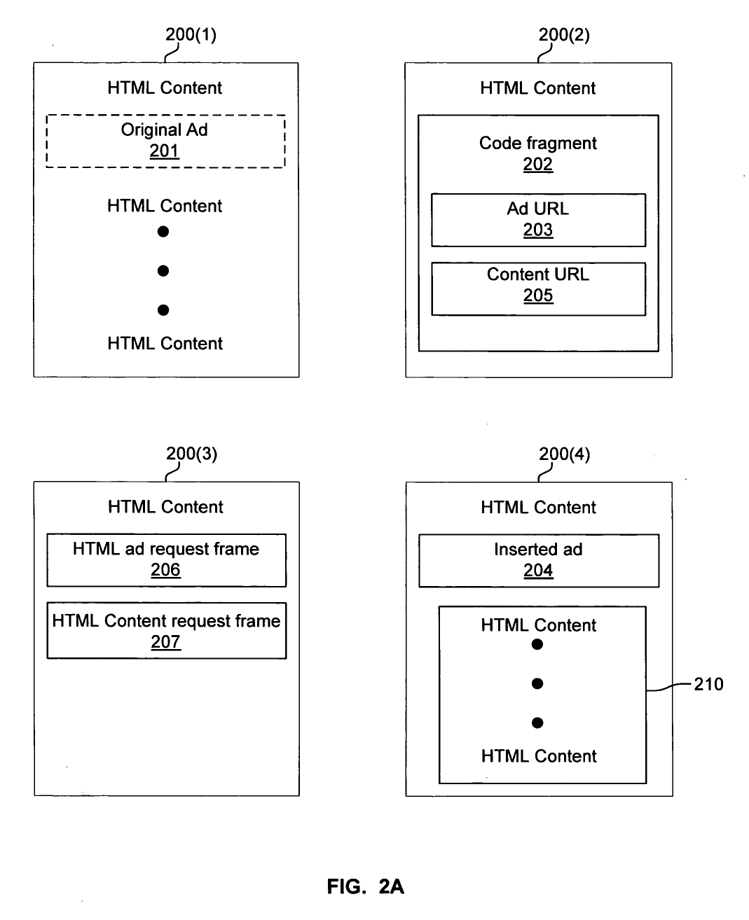

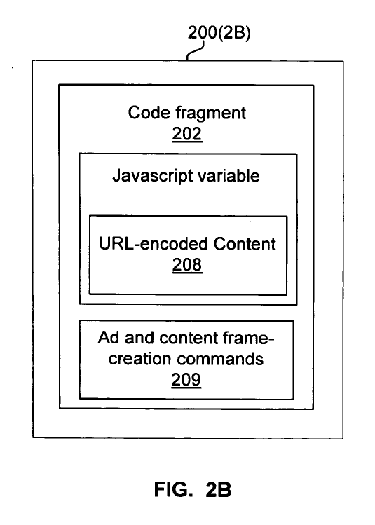

Ad Insertion Module 125 (further described with respect to FIG. 2A, below) takes as input an HTML page (typically provided from a target web server 120) and modifies it so that the web client (browser) is instructed to request advertising content from an Ad Content Server 112 (described below) by inserting a code fragment into the HTML page. Ad Content Server 112 and proxy server 111 are also collectively referred to herein as portal 110.

Ad Content Server 112 is a server which implements the HTTP protocol. Ad Content Server 112 takes a request for a web page from web client/browser 101 and then requests insertion an ad from Ad Placement Module 130 (described below). The Ad Content Server also provides the Ad Placement Module 130 with various meta-information about the request, including the originating IP address and other meta-information which identifies the specific venue, such as the geographic location, type of establishment, etc., from which the request originated. When the Ad Placement Module 130 responds that a given ad should be inserted in the requested web page, the Ad Content Server 112 returns the binary content for that ad to the web client 101. Inserted advertising material may be in various file formats, including PNG, JPEG, Flash and SVG.

In an alternative embodiment (described below with respect to FIG. 1B), Ad Content Server 112 may be functionally combined with the proxy server.

Ad Placement Module 130 responds to a request from Ad Content Server 112 to insert or place an ad at a specific location on the web page returned to the user by the proxy server. Various business logic may be applied to determine which ad should be placed. The Ad Placement Module 130 selects ads to be inserted by evaluating factors such as the venue (i.e., the geographical location of the web client), as well as other meta information such as the ‘type’ of venue {for example, a restaurant}. Specific ads are chosen from the available pool of advertisements to be placed. In an exemplary embodiment, these advertisements are stored in database 140, which may be either locally or remotely located with respect to the rest of the present system. When an advertisement is selected to be placed, Ad Placement Module 130 may notify an optional Metric Tracking Module 135 (described below) that the placement occurred, for the purposes of real-time monitoring, financial book-keeping, and the like.

Metric Tracking Module 135 is a module which collects information about the behavior of the platform in real-time for the purpose of collating and storing metric information. Metric Tracking Module 135 is coupled to Ad Placement Module 130, and connected to one or more local or external sources 145 that provide metric information via an interface such as SOAP (Simple Object Access Protocol). The Metric Tracking Module collects and processes this data for storage in a backing store, such as Database 140.

The architecture of the present system is flexible, allowing for many choices in designing a physical deployment. It is minimally required that web client TCP/IP traffic is able to be re-routed to portal 110, and the web client must have unfettered access to portal 110. Portal 110 may be on-site with CPE 105 or remotely placed with respect to the user/web client 101, as shown in FIG. 1A.

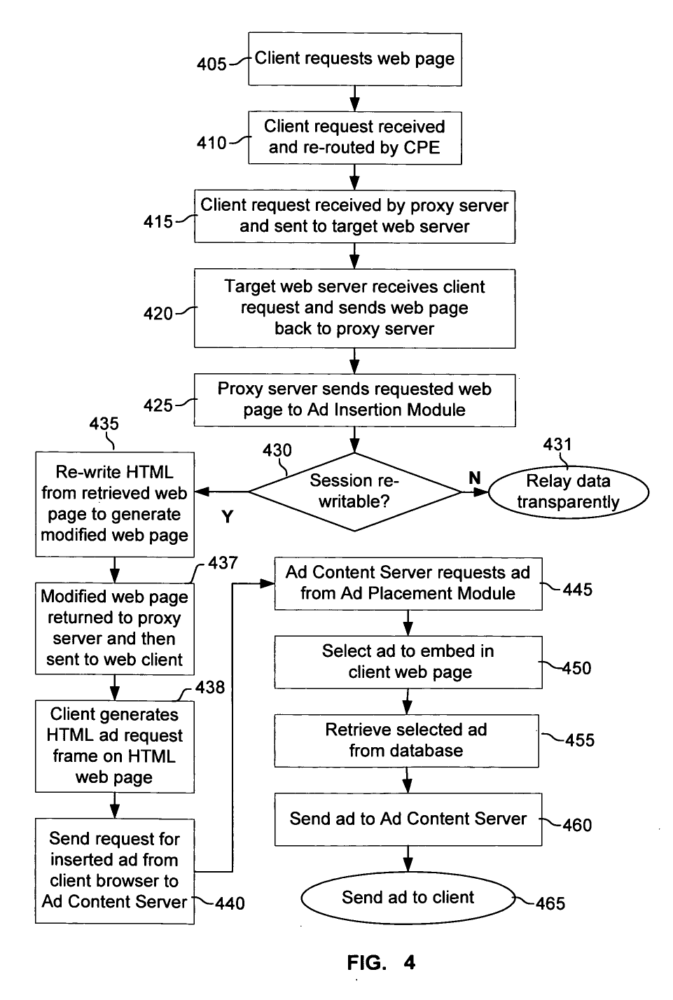

FIG. 2A is a diagram sequentially illustrating exemplary contents of a user-requested web page during the process of ad insertion. Initially (as described in detail below with respect to FIG. 4), a request from web client/browser 101 is received by proxy server 111 and sent to target web server 120. HTML web page 200(1) is then sent from target web server 120 to proxy server 111, in response to the web client request for the web page. Each HTML web page 200(1) provided by web server 120 is modified, if possible, by the Ad Content Server 112 to request new advertising content selected by an Ad Placement Module 130 (described below). The requested web page 200(1) may already contain original advertising material 201, or may not contain any advertising at all. In either event, the content of the web page received from web server 120 is re-written by Ad Insertion Module 125, if possible, to contain a code fragment 202, before the page is returned to the requesting web client 101, to effect subsequent insertion of selected advertising.

Mechanisms by which advertising content may be placed into the web page requested by a web client 101 include redirection and encapsulation, as described below.

Redirection

In an exemplary embodiment, after an HTTP request is received from a web client 101, portal 110 sends the request to the appropriate foreign (target) server 120, which hosts the content the web client user has requested. A response is returned by the target server to portal 110, which evaluates the response for several criteria, including mime-type and extension. If the response is an image, video, or otherwise of unknown content, it is passed on to the end-user without modification. If the response is a web page, identified by its mime-type, extension, or textual content, then the response data is modified (by portal 110) by inserting a Javascript or other code (applet) fragment 202 into the <HEAD> tag of the document, to generate web page 200(2). If no <HEAD> tag is present, one is created.

An example of a skeleton web page 200(2), including addressing information for advertising to be placed on the client-requested web page and also for the web page HTML content (ad URL 203, and content URL 205, respectively), is set forth below:
<head><title>Connect IT Portal</title><FRAMESET ROWS=“100,*”><frame src=http://www.ashpool.com/lib/cit/ad.html [ad URL 203] noresize=“true” name=“ad”>‘<frame src=“http://www.ashpool.com” name=“content” [content URL 205] noresize=“true”>’</frameset>

HTML web page 200(2) shows an inserted code fragment 202. When executed by web client/browser 101, code fragment 202 evaluates the current condition of the web page 200(2). If an ad request frame is already in place, code fragment 202 generates a request for an ad selected by the present system. If an HTML ad request frame 206 is not detected on the web page, then the code fragment 202 instructs web client/browser 101 to create an ad request frame 206, which, when executed by web client/browser 101, requests insertion of advertising content from the Ad Content Server 112. Web client/browser 101 is thus redirected to a resource on portal 110 (e.g., Ad Insertion Module 125) that generates a page 200(3) which contains an ad request frame 206 which is set to request ad content from ad server 112, and an HTML content frame 207 which is set to request the page originally requested by the browser from the target web server. After web page 200(3) is sent to web client/browser 101, the page is executed by the web browser to generate HTML web page 200(4), which includes an inserted ad 204 selected by the present system.

The code fragment 202 that is inserted into HTML page 200(2) to cause subsequent insertion of an advertisement may take several forms. In the simplest form, code fragment 202 is JavaScript included into the HTML page in a manner such that the fragment is executed inside the web browser 101 when the web page is loading.

In addition to the insertion of the code fragment 202, the retrieved web page is searched for Javascript references to the ‘top’ window, and replaced with references that identify the content window 210. This procedure prevents foreign websites from disabling or removing the inserted ad request frame 206 through conventional means.

Encapsulation

In an alternative embodiment, after a response is returned by the target server to portal 110 and evaluated, as described above, if the response is a web page, identified by either its mime-type, extension, or textual content, then the response data is encoded using the URL (Uniform Resource Locator) encoding format (T. Berners-Lee, et al., RFC 1738 Uniform Resource Locators, http://www.faqs.org/rfcs/rfc1738.html). The encoded page is then encapsulated into a template of Javascript code by inserting the URL-encoded version of the page into a Javascript variable in code fragment 202.

FIG. 2B shows web page 200(2B), including URL-encoded content 208, which has been encapsulated into a Javascript variable 210. The Javascript includes commands 209 instructing the web client/browser 101 to create two frames, an advertising content frame, and a page content frame, to generate web page The page content is then URL decoded by the client browser and then written into the content frame. The presence of the ad frame causes the browser to request advertising content from ad server 112.

Intra-System Communication

In one embodiment, network 107 is a Virtual Private Network (VPN). A Virtual Private Network is a private network that is configured within a public network (a carrier's network or the Internet) in order to take advantage of the economies of scale and management facilities of large networks. VPNs are widely used by enterprises to create wide area networks (WANs) that span large geographic areas, to provide site-to-site connections to branch offices and to allow mobile users to connect to corporate local area networks (LANs).

For years, common carriers have built VPNs that appear as a private national or international network to each customer, although, in fact, the VPNs share the same physical backbone trunks with many customers. VPNs have been built over X.25, Switched 56, frame relay and ATM technologies as well as IP networks including the Internet.

There are a number of types of VPNs. Secure VPNs use cryptographic tunneling protocols to provide the necessary confidentiality (preventing ‘snooping’), sender authentication (preventing identity spoofing), and message integrity (preventing message alteration) to achieve the privacy intended. Secure VPN protocols include PPTP (point-to-point tunneling protocol), developed jointly by a number of companies, including Microsoft.

Trusted VPNs do not use cryptographic tunneling, and instead rely on the security of a single provider's network to protect the traffic. Multi-protocol label switching (MPLS) is commonly used to build trusted VPNs. Other protocols used by VPNs include:

L2F (Layer 2 Forwarding), developed by Cisco;

L2TP (Layer 2 Tunneling Protocol), including work by Microsoft and Cisco; and

L2TPv3 (Layer 2 Tunneling Protocol version 3).

Several protocols are presently used to provide security over the Internet. For brief transactions at a web site, SSL is widely used. For extended, secure transmissions, IPsec, L2TP and PPTP are used to provide secure ‘tunnels’ over the Internet. L2TP (Layer 2 Tunneling Protocol) is a protocol that allows a PPP session to travel over multiple links and networks. L2TP is used to allow remote users access to the corporate network. PPP is used to encapsulate IP packets from the user's PC to the ISP, and L2TP extends that session across the Internet. Any of the above protocols may be used by the present system. L2TP does not include encryption (as does PPTP), but is often used with IPsec in order to provide virtual private network (VPN) connections from remote users to a corporate LAN.

PPTP (Point-to-Point Tunneling Protocol) is a protocol that is used to create a virtual private network (VPN) over the Internet. PPTP encapsulates a network protocol (IP, IPX, etc.) and transports it over IP (Internet protocol). Thus if IP is the original protocol, IP packets ride as encrypted messages inside PPTP packets running over IP. PPTP is based on the point-to-point protocol (PPP) protocol and the generic routing encapsulation (GRE) protocol. PPTP may use encryption performed by Point-to-Point Encryption (MPPE). Protocols such as L2TP or PPTP may be used for the VPN 107.

In one embodiment, traffic from each of the customer sites is ‘back-hauled’ into the central data-center using VPN 107. “Backhaul” may be defined as the process of transmitting information to a central point from which it can be distributed over a network. Backhaul services usually carry traffic on a point-to-point basis, without making complex switching decisions about where traffic should be sent. A VPN backhaul to a large server may be employed to handle communication between web client 101 and servers 111 and 112, in which case the customer premises equipment 105 may be any set of devices that support a VPN.

In an exemplary embodiment, the present system operates by having traffic for TCP port 80 from client computer 102 re-routed to proxy server 111 or Ad Content Server 112, depending on the particular stage of the ad insertion process. Routing traffic (i.e., HTTP transmissions directed to an Internet [IP] address) to a particular device, e.g., to proxy server 111, can be accomplished by using well-known networking technologies. For example, traffic may be re-routed via a NAT (Network Address Translation) device, or the traffic can be ‘captured’ by terminating and intercepting VPN (Virtual Private Network) traffic.

NAT is a commonly used IP translation and mapping technology. Using a device or piece of software that implements NAT allows multiple devices to share a single internet connection over a single IP address. NAT acts as an interpreter between two networks. When a computer on a private network requests data from a public network, such as the internet, the NAT device will open a conduit between an originating computer and a public destination system. When the public system returns results from the request, it is passed back through the NAT device to the requesting computer.

In one embodiment, software modules 125, 130, and 135 are installed on a server that is located in a data center, at a centralized location. Processing the traffic for all customer sites at one central location offers an economy of scale over deploying many copies of it at each customer location, but the present system works essentially equally well with either method.

Certain aspects of the present system platform depend on persistent state data that is stored throughout the life of the platform. This persistent data includes log information, configuration of business rules, and advertising content. This data may be stored in, for example, a SQL (such as ANSI SQL92, or a variant thereof) database 140, system files containing XML (extensible Markup Language) data, system files containing structured binary data, and/or system files containing unstructured data. No particular SQL implementation is required for operation of the present system, as applicable database versions and techniques are well known in the industry. In an exemplary embodiment, the present system employs either Oracle RDBMS or MySQL as a preferred SQL implementation. Alternatively, a non-SQL database system 140 may be employed by the present system.

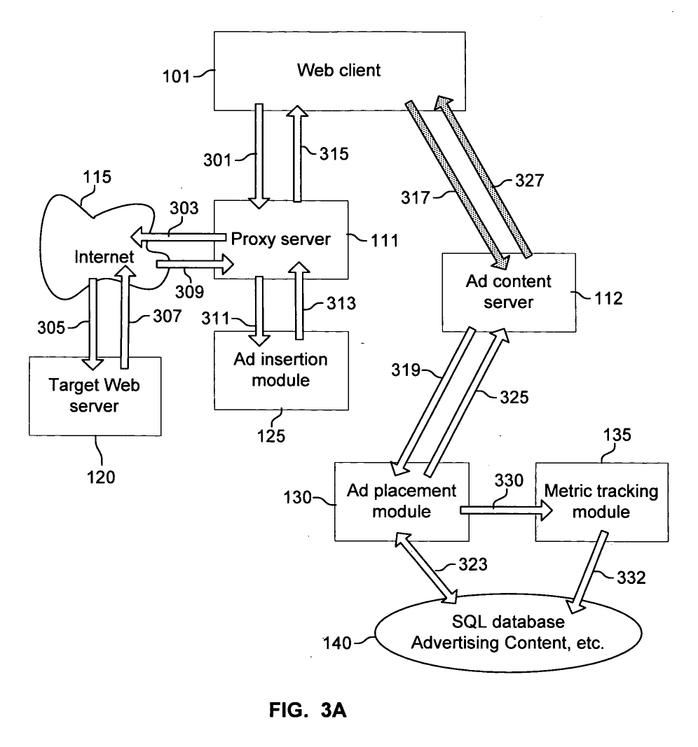

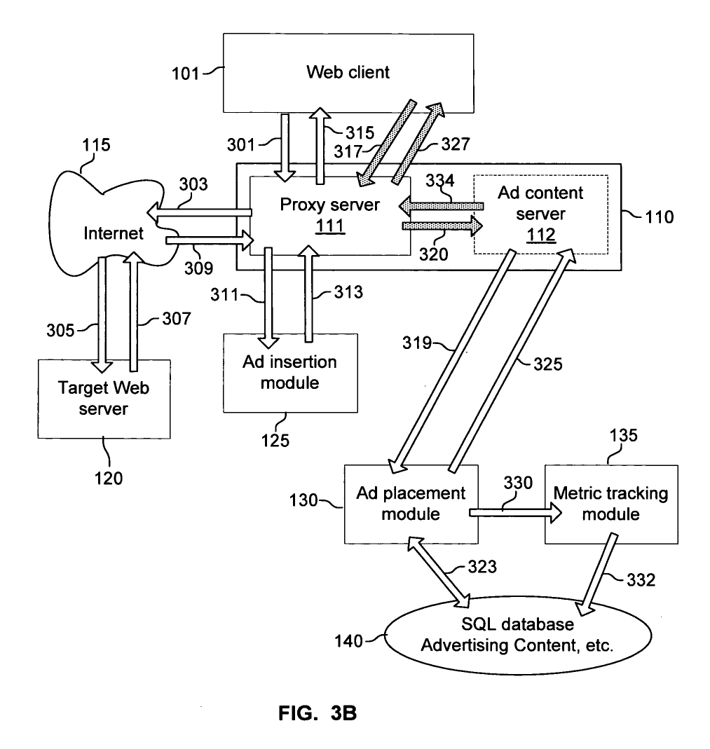

FIG. 3A is a diagram illustrating exemplary data flow in the present system, and FIG. 4 is a flowchart showing an exemplary set of steps performed in operation of one embodiment of the present system. Operation of the present system is best understood by viewing FIGS. 3A and 4 in conjunction with one another.

As shown in FIG. 4, at step 405, web client/browser 101 makes a user-initiated request for a particular web page 200(1) on a target Internet web server 120. At step 410, the HTTP-based request for the web page initially directed to the target web site's web server 120 is re-directed (re-routed) to proxy server 111 via customer premises equipment 105, which intercepts all detected HTTP traffic from the web client 101, regardless of destination address. Transmission of web page 200(1) to proxy server 111 is shown in FIG. 3A by arrow 301. When the client request is received by proxy server 111, the server forwards the web page request to target web server 120, at step 415, and as shown by arrow 303 in FIG. 3A.

At step 420, the target web server 120 receives the web page request (as indicated by arrow 305) and sends the web page back to proxy server 111 via the Internet, as shown by arrows 307 and 309. At step 425, proxy server 111 sends the requested web page to Ad Insertion Module 125, as indicated by arrow 311. At step 430, Ad Insertion Module 125 determines whether the web page is re-writeable. If the web page is not re-writeable, then at step 431, the web page data is transparently relayed, via proxy server 111, to the web client 101. Otherwise, at step 435, Ad Insertion Module 125 re-writes the HTML from the retrieved web page 200(1) to generate modified web page 200(2) including code fragment 202. A code fragment 202 may replace or supplement some or all of the original HTML advertising-request HTML code fragments on web page 200(1). Each code fragment 202 contains the URL-encoded address of the Ad Content server 112, so that when the fragment is executed by web client/browser 101, a request for an ad is directed to the Ad Content server. Code fragment 202 may be inserted into web page 200(1) regardless of whether or not the web page initially contains any advertising-request code.

At step 437, the modified web page 200(2) is returned to proxy server 111 from Ad Insertion Module 125 (arrow 313), and then sent to web client/browser 101 (arrow 315). Browser 101 then generates HTML ad request frame 206 on HTML web page 200(3), at step 438. At step 440, the request for the ad to be inserted is generated from web page 200(3), by web client/browser 101, and then sent, via network 107, to the Ad Content Server 112 (arrow 317). The ad insertion request, when executed by browser 101, causes code associated with ad request frame 206 (e.g., code fragment 202) to be executed. Execution of this code fragment generates an HTTP request for an ad which is sent to the Ad Content server 112. At step 445, Ad Content Server 112 requests an ad from Ad Placement Module 130, as indicated by arrow 319.

At step 450, Ad Placement Module 130 selects an ad 204 to embed in the web page content to replace all or some of the pre-existing advertising material. If there is no pre-existing advertising on the target web page, advertising may be inserted on the page, nevertheless. At step 455, the selected ad 204 is retrieved from database 140 by Ad Placement Module 130, as indicated by arrow 323. In an exemplary embodiment, Ad Placement Module 130 also sends information identifying the selected ad 204 to Metric tracking module 135 (arrow 330), which stores all or part of the information in database 140 (arrow 332).

At step 460, Ad Placement Module 130 sends ad 204 (binary content) to Ad Content Server, as indicated by arrow 325. At step 465, Ad Content Server 112 sends ad 204, via network, to web client 101 for inclusion in client's web page 200(4), as indicated by arrow 327.

FIG. 1B is a diagram of an alternative embodiment of the present system in which the Ad Content Server 112 is functionally combined with proxy server 111 to collectively comprise portal 110. As shown in FIG. 1B, Ad Content Server 112 is coupled to proxy server 111, and is not directly connected to network 107, in contrast to the embodiment shown in FIG. 1A. Thus, in the present embodiment, proxy server 111 handles all communication with network 107. In this embodiment, Ad Content Server 112 provides the same functionality as described with respect to FIG. 1A, except for handling web page requests from web client 101 and returning binary ad content to the web client 101.

FIG. 3B is a diagram illustrating alternative data flow corresponding to the embodiment of FIG. 1B. Differences in data flow between the embodiment of FIGS. 1A/3A and the alternative embodiment of FIGS. 1B/3B are indicated by shaded arrows 317, 320, 327, and 334 in FIG. 3B vs. shaded arrows 317 and 327 in FIG. 3A. There are several differences between the two embodiments:
In the embodiment of FIG. 1B/3B, the request for an ad to be inserted in web page 200(4) [at step 440 in FIG. 4] is first received by proxy server 111, and then relayed to Ad Content Server 112, as indicated by respective arrows 317 and 320 in FIG. 3B.
The ad data 204 sent directly from Ad Content Server 112 to web client 101 in the FIG. 1A/3A embodiment (indicated by arrow 327 in FIG. 3A) is relayed to proxy server 111 in the FIG. 1B/3B embodiment, as indicated by shaded arrow 334 in FIG. 3B. The ad data is then transmitted to web client 101 [at step 465 in FIG. 4] via proxy server 111 instead of Ad Content Server 112, as indicated by arrow 327 in FIG. 3B.

Thus in the FIG. 1B/3B embodiment, proxy server 111, rather than Ad Content Server 112, directly engages in communication with web client 101.

Certain changes may be made in the above methods and systems without departing from the scope of that which is described herein. It is to be noted that all matter contained in the above description or shown in the accompanying drawings is to be interpreted as illustrative and not in a limiting sense. For example, the methods shown in FIGS. 3A, 3B, and 4 may include steps other than those shown therein, and the system shown in FIGS. 1A and 1B may include different components than those shown in the drawings. The elements and steps shown in the present drawings may be modified in accordance with the methods described herein, and the steps shown therein may be sequenced in other configurations without departing from the spirit of the system thus described. The following claims are intended to cover all generic and specific features described herein, as well as all statements of the scope of the present method, system and structure, which, as a matter of language, might be said to fall therebetween.

What is claimed is:

1. A method for insertion of advertising content in an Internet web page, located on a target web site and requested by a web client, comprising:
intercepting an HTTP request, from the web client, for the web page;
retrieving the web page from the target web site;
re-writing code on the web page to generate a modified web page including an ad insertion code fragment; and
sending the modified web page to the web client;
wherein the code fragment, when executed by the web client, causes the advertising content to be displayed.

2. The method of claim 1, including the step of sending, to a proxy server, the request that was intercepted; wherein the proxy server performs the steps of retrieving the web page from the target web site and sending the modified web page to the web client.

3. The method of claim 1, including the steps of sending, to a proxy server, the request that was intercepted and the request for the advertising content;
wherein the proxy server performs the steps of retrieving the web page from the target web site, sending the modified web page to the web client, receiving the request from the web client for the advertising content, and sending the advertising content to the web client.

4. The method of claim 1, including the step of selecting the advertising content by evaluating factors including the venue of the web client and the type of the venue.

5. The method of claim 1, wherein the code fragment evaluates the current condition of the web page; and wherein:
if an ad request frame is already in place, the code fragment generates a request for an ad selected by the present system;
if an HTML ad request frame is not detected on the web page, then the code fragment instructs the web client to create an ad request frame which, when executed by the web client, causes the advertising content to be displayed.

6. A method for insertion of advertising content in an Internet web page, located on a target web site and requested by a web client, comprising:
intercepting a request from the web client for the web page;
retrieving the web page from the target web site in response to forwarding, to the target web site, the request that was intercepted;
re-writing HTML code on the web page to produce a modified web page including an ad insertion code fragment;
sending the modified web page to the web client;
wherein the ad insertion code fragment, when executed by the web client, causes an advertising content request to be generated; and
sending the advertising content to the web client in response to the request therefor.

7. The method of claim 6, including the step of sending, to a proxy server, the request that was intercepted; wherein the proxy server performs the steps of retrieving the web page from the target web site and sending the modified web page to the web client.

8. The method of claim 6, including the steps of sending, to a proxy server, the request that was intercepted and the request for the advertising content;
wherein the proxy server performs the steps of retrieving the web page from the target web site, sending the modified web page to the web client, receiving the request from the web client for the advertising content, and sending the advertising content to the web client.

9. The method of claim 6, including the step of selecting the advertising content by evaluating factors including the venue of the web client and the type of the venue.

10. The method of claim 6, wherein the ad request frame generates a request for the advertising content when the web page is loaded by the web client.

11. The method of claim 6, wherein the advertising content sent to the web client is different from advertising material included in the web page retrieved from the target web site.

12. The method of claim 6, wherein the code fragment evaluates the current condition of the web page; and wherein:
if an ad request frame is already in place, the code fragment generates a request for an ad selected by the present system;
if an HTML ad request frame is not detected on the web page, then the code fragment instructs the web client to create an ad request frame which, when executed by the web client, causes the advertising content to be displayed.

13. A method for insertion of advertising content in an Internet web page, located on a target web site and requested by a web client, comprising:
intercepting an HTTP request, from the web client, for the web page;
retrieving the web page from the target web site in response to forwarding, to the target web site, the request that was intercepted;
re-writing HTML code on the web page retrieved from the target web site to produce a modified web page including an ad insertion code fragment;
sending the modified web page to the web client;
wherein the ad insertion code fragment, when executed by the web client, causes an advertising content request to be generated;
executing the ad request frame to generate an HTTP request for the advertising content; and
sending the advertising content to the web client in response to the request therefor.

14. The method of claim 13, including the step of sending, to a proxy server, the request that was intercepted; wherein the proxy server performs the steps of retrieving the web page from the target web site and sending the modified web page to the web client.

15. The method of claim 13, including the steps of sending, to a proxy server, the request that was intercepted and the request for the advertising content;
wherein the proxy server performs the steps of retrieving the web page from the target web site, sending the modified web page to the web client, receiving the request from the web client for the advertising content, and sending the advertising content to the web client.

16. The method of claim 13, including the step of selecting the advertising content by evaluating factors including the venue of the web client and the type of the venue.

17. The method of claim 13, wherein the ad request frame generates a request for the advertising content when the web page is loaded by the web client.

18. The method of claim 13, including the step of sending, to a proxy server, the request that was intercepted; wherein the proxy server performs the steps of retrieving the web page from the target web site and sending the modified web page to the web client.

19. The method of claim 13, including the steps of sending, to a proxy server, the request that was intercepted and the request for the advertising content; wherein the proxy server performs the steps of retrieving the web page from the target web site, sending the modified web page to the web client, receiving the request from the web client for the advertising content, and sending the advertising content to the web client.

20. The method of claim 13, including the step of selecting the advertising content by evaluating factors including the venue of the web client and the type of the venue.

21. The method of claim 13, wherein the ad request frame generates a request for the advertising content when the web page is loaded by the web client.

22. The method of claim 13, wherein the advertising content sent to the web client is different from advertising material included in the web page retrieved from the target web site.

23. The method of claim 13, wherein the request for the web page is a wireless transmission intercepted in a hotspot.

24. A method for insertion of advertising content in an Internet web page, located on a target web site and requested by a web client, comprising:
receiving a request, from the web client, for the web page by intercepting an HTTP transmission from the web client;
sending the request to a proxy server;
forwarding the request for the web page, from the proxy server the target web site;
receiving the web page from the target web site;
inserting a code fragment in the web page received from the target web site;
sending the web page containing the code fragment to the web client;
wherein the ad insertion code fragment, when executed, causes an ad request frame to be generated on the web page;
receiving a request for the advertising content by an ad content server, in response to the ad request frame being executed by the web client; and
sending the advertising content from the ad content server to the web client, in response to receipt of the request therefor.

25. The method of claim 24, wherein the step of inserting the code fragment includes re-writing HTML in the web page received from the target web site to generate a modified web page including a code fragment, in the web page, which generates an ad request frame on the web page; wherein, in response to the ad request frame being clicked on by a user of the web client, the ad request frame initiates a request for the advertising content to be generated by an entity other than the target web site.

26. The method of claim 24, including the step of selecting the advertising content by evaluating factors including the venue of the web client and the type of the venue.

27. The method of claim 24, wherein the request for the web page is a wireless transmission intercepted in a hotspot.

28. The method of claim 24, wherein the advertising content sent to the web client is different from advertising material included in the web page retrieved from the target web site.

29. A system for insertion of advertising content in an Internet web page, located on a target web site and requested by a web client, the system comprising:
customer premises equipment that intercepts an HTTP request, from the web client, for the web page;
a proxy server that receives the request from the web client, forwards the request to the target web site, and sends the web page back to the proxy server;
an ad insertion module, coupled to the proxy server and to a database containing the advertising content;
an ad content server that receives the web page from the proxy server;
wherein the HTML on the retrieved web page is re-written by the ad insertion module to generate a modified web page including a code fragment which generates an ad request frame when loaded by the web client; and
wherein the modified web page is sent to the web client by the ad content server;
wherein a request for the advertising content to be inserted in the web page is generated in response to the ad request frame being executed by the web client; and
wherein, in response to receiving the request for the advertising content, the ad content server sends the advertising content to the web client for inclusion in the web page.

30. The system of claim 29, wherein the proxy server replaces the ad content server, and sends the modified web page to the web client, receives the request for the advertising content to be inserted in the web page, and sends the advertising content to the web client.

31. The system of claim 29, including an ad placement module that provides, to the ad insertion module, the advertising content to be embedded in the web page.

32. The system of claim 31, wherein the ad placement module selects ads to be inserted by evaluating factors including venue of the web client and the type of venue

33. The system of claim 29, wherein the advertising content embedded in the web page replaces at least some of the pre-existing advertising material therein.

34. The system of claim 29, wherein the ad request frame is executed when clicked on by a user of the web client.

35. The system of claim 29, wherein the modified web page is generated only if the web page HTML is re-writeable.

36. The method of claim 29, wherein the advertising content inserted in the web page is selected by evaluating factors including the venue of the web client and the type of the venue.

37. A system for insertion of advertising content in an Internet web page, located on a target web site and requested by a web client, comprising:
means for intercepting a request from the web client for the web page;
means for retrieving the web page from the target web site in response to forwarding, to the target web site, the request that was intercepted;
means for re-writing HTML code on the web page to produce a modified web page including an ad insertion code fragment;
means for sending the modified web page to the web client;
wherein the ad insertion code fragment, when executed, causes an advertising content request to be generated; and
means for sending the advertising content to the web client in response to the request therefor.

38. The system of claim 37, wherein the advertising content inserted in the web page is selected by evaluating factors including the venue of the web client and the type of the venue.

39. The system of claim 37, wherein the advertising content sent to the web client is different from advertising material included in the web page retrieved from the target web site.

40. The method of claim 37, wherein the code fragment evaluates the current condition of the web page; and wherein:
if an ad request frame is already in place, the code fragment generates a request for an ad selected by the present system;
if an HTML ad request frame is not detected on the web page, then the code fragment instructs the web client to create an ad request frame which, when executed by the web client, causes the advertising content to be displayed.
